(19) United States
(12) Patent Application Publication
(10) Pub. No.: US 2008/0268699 A1
(43) Pub. Date: Oct. 30, 2008

(54) Connector and housing thereof

(75) Inventors: Yun Zuo, Taoyuan Hsien (TW); Yu-Yuan Tai, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/068,838

(22) Filed: Feb. 12, 2008

(30) Foreign Application Priority Data
Apr. 27, 2007 (TW) 96114951

(51) Int. Cl. H01R 3/00

(52) U.S. Cl. 439/490

(57) ABSTRACT

A connector is provided. The connector includes a lighting element, a plurality of pins; and a housing covering the pins. The house includes at least one slot receiving the lighting element and having a plurality of engaging elements disposed on the slot and at least one stopper disposed at an open side of the slot.

### BACKGROUND OF THE INVENTION

1. Field of the Invention

The invention relates to a connector and a housing thereof, and in particular to a connector and a housing with a simpler fabricating procedure and capability for reworking.

2. Description of the Related Art

As the internet is broadly used, a connector with high reliability is essential for internet connection. Referring to FIGS. 1A and 1B, a conventional RJ-45 type connector 1 is equipped with a LED 12 to identify the connection of the connector 1 with other elements. In a conventional structure, a slot 13 is formed on a housing 11 of the connector 1 for receiving the LED 12. When the LED 12 is inserted into the slot 13, glue is added to the gap between the LED 12 and the housing 11 and then baked to secure the LED 12 to the slot 13. During the baking process, the LED 12 is usually damaged, which causes reduction of connector 1 yield.

In addition, as the LED 12 is glued to the housing 11, if the LED 12 is found to have any defects, the connector 1 must be discarded, increasing manufacture cost.

### BRIEF SUMMARY OF INVENTION

A connector and a housing thereof according to the invention are disclosed. The connector includes a lighting element, a plurality of pins, and a housing. The housing covers the pins and includes a slot, a plurality of engaging elements and at least one stopper. The lighting element is disposed in the slot. The engaging elements are disposed in the housing which is close to the slot. The stopper is disposed at the open side of the slot. When the lighting element is disposed in the slot, the engaging elements contact the lighting element, and the stopper contacts the engaging element and the lighting element.

The slot is defined by a bottom and two lateral walls extending from the bottom along a longitudinal direction. The engaging elements are disposed on the lateral walls. The engaging elements are integrally formed with the lateral walls as a single piece.

The engaging elements can be stripe-shaped and can be made of material capable of temporally deforming.

The stopper has a first part and a second part. The first part is received in the slot. The housing further includes a hole for accommodating the second part.

The stopper partially covers the lighting element.

The first part of the stopper abuts the engaging element and the lighting element.

The connector further includes a cover disposed above the housing and reveals the slot. The cover can be T-shaped.

The lighting element is a light emitting diode, an organic electroluminescent device or a laser diode.

The specific terminal is a RJ-45 connector, a RJ-11 connector or a USB connector.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given herein below and the accompanying drawings which are given by way of illustration only, and thus are limitative of the present invention, and wherein:

FIG. 1A is a schematic view of a conventional RJ-45 connector without LED; and

FIG. 1B is a schematic view of the conventional RJ-45 of FIG. 1A connector with LED;

FIG. 2 is an embodiment of a connector of the invention;

FIG. 3A is a schematic view of a housing of the connector of FIG. 2;

FIG. 3B is a enlarged view of a slot of the connector of FIG. 3A; and

FIG. 4 is a schematic view of the assembly of the stopper and the lighting element of the invention.

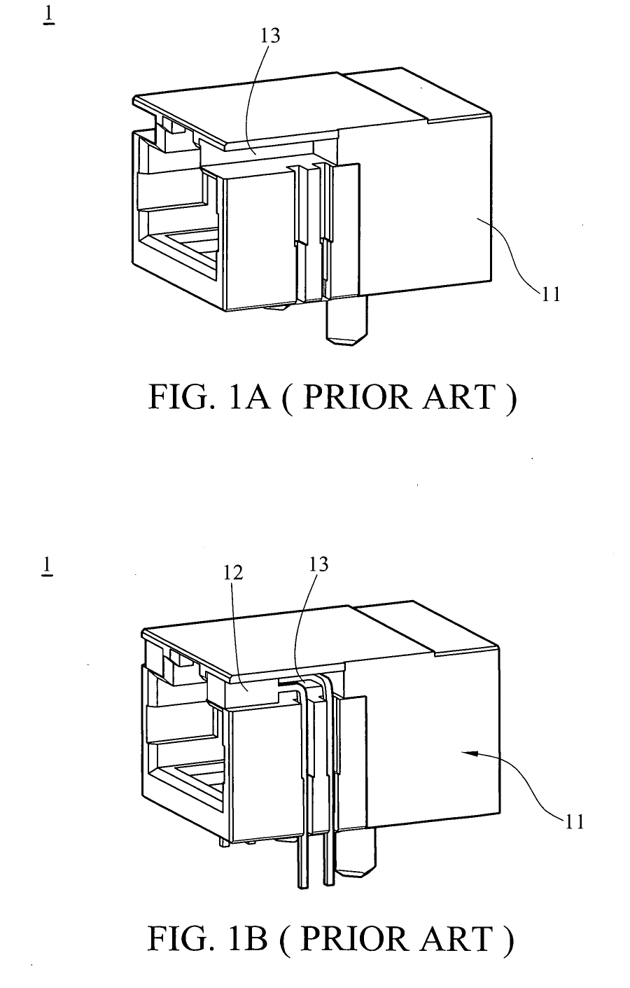

### DETAILED DESCRIPTION OF INVENTION

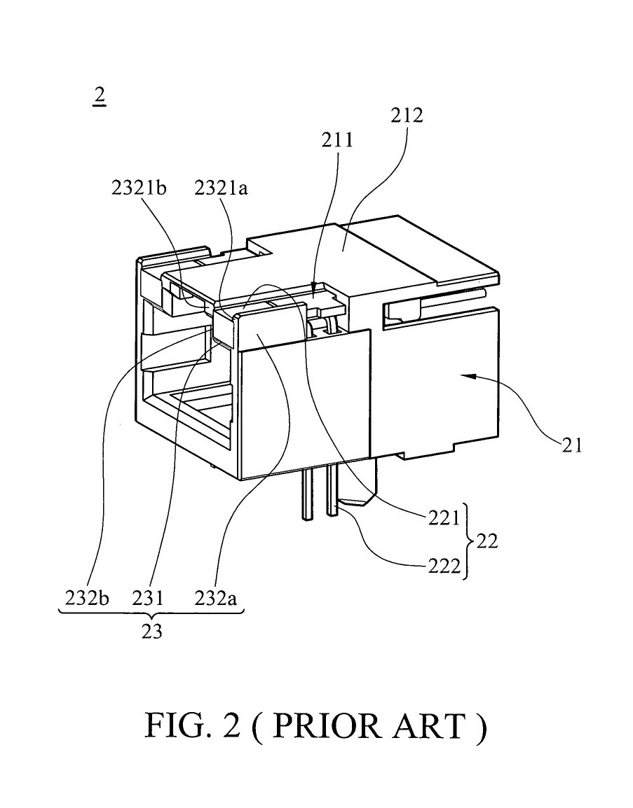

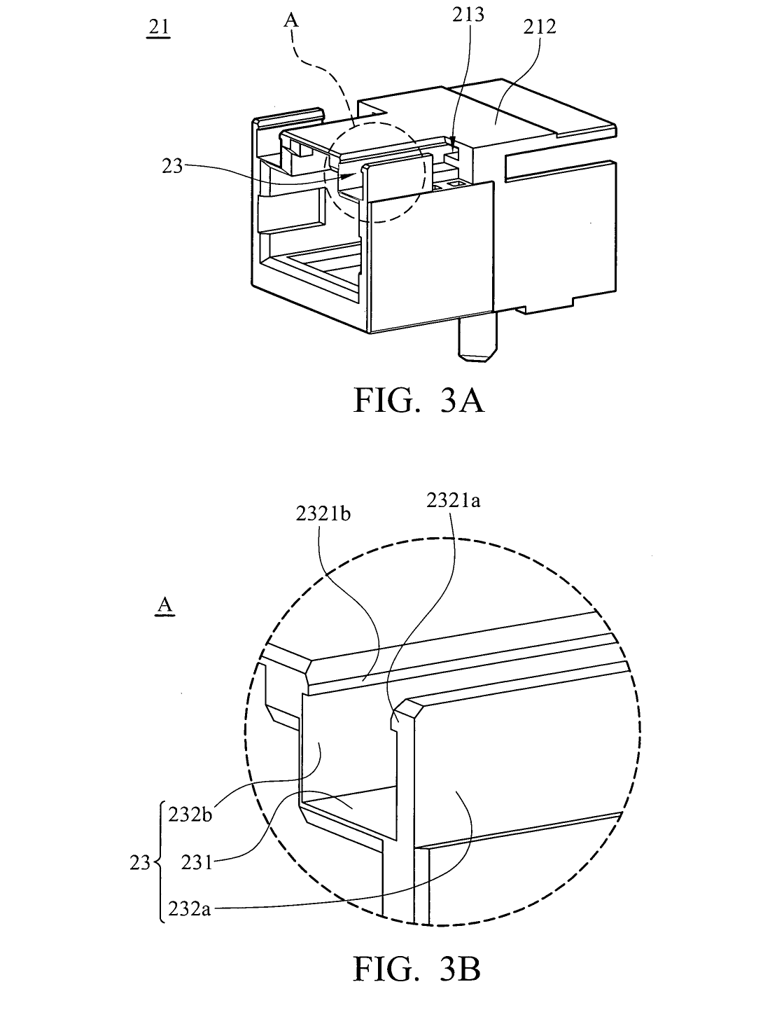

Referring to FIGS. 2, 3A and 3B, a connector 2 according to the present invention includes a lighting element 22, a plurality of pins (not shown) and a housing 21. The housing 21 covers the pins (not shown) and includes a slot 23, a plurality of engaging elements 2321a, 2321b and at least one stopper 211. The slot 23 is defined by a bottom 231 and two lateral walls 232a and 232b to accommodate the lighting element 22. The engaging elements 2321a and 2321b are disposed on the lateral walls 232a and 232b, respectively. The engaging elements 2321a and 2321b are attached to the lateral walls 232a and 232b by binding, engaging, latching or welding. The engaging elements 2321a and 2321b can also be integrally formed with the lateral walls 232a and 232b as a monolithic piece. The engaging elements 2321a and 2321b contact the lighting element 22. A stopper 211 is disposed at an open side of the slot 23 and abuts the engaging elements 2321a and 2321b. As the lighting element 22 has at least one lead 222, the stopper 211 abuts the lead 222 with the aid of the engaging elements 2321a and 2321b. The pins of the connector 2 are connected to a specific terminal which can be a RJ-45 terminal, a RJ-11 terminal or an USB connector.

To simplify the manufacture process, a cover 212 is disposed on the housing 21. The cover 212 can be T-shaped, whereby the slot 23 is revealed from the lateral sides of the cover 212. The lighting element 22, such as a light emitting diode, an organic electroluminescent device or a laser diode, can be disposed in the slot 23. During the disposition, as a distance between the engaging elements 2321a and 2321b is slightly smaller than the width of the body 221 of the lighting element 22 so that the engaging elements 2321a and 2321b abut the body 221 first. Next, when a force is exerted on the engaging elements 2321a and 2321b, the engaging elements 2321a and 2321b, which are stripe-shaped, deform temporally to allow the body 221 to pass by and enter the slot 23. When the lighting element 22 contacts the bottom 231 of the slot 23, the body 221 is completely accommodated in the slot 23. When the force on the engaging elements 2321a and 2321b is eliminated, the engaging elements 2321a and 2321b return to original condition. Therefore, the body 221 is held by the slot 23 and cannot escape therefrom.

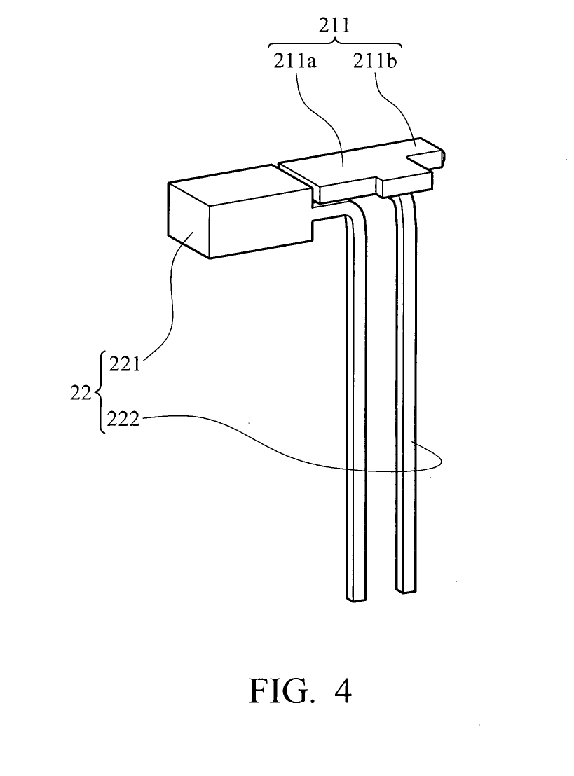

To improve the connection, more than one stoppers 221 can be disposed to fix the lead 222 of the lighting element 22. Referring to FIG. 4, the stopper 211 is installed after the lighting element 22 is accommodated in the slot 23 (omitted in FIG. 4). The stopper 211 is made of polymer such as plastic and has a first part 211a and a second part 211b. Referring to FIG. 4 in view of FIG. 3A, at the beginning of the installation, the second part 211b is accommodated into a hole 213 and fixed thereto. The first part 211a is inserted into the slot 23 by the following described method. The first part 211a is partially received in the slot 23. The area of the first part 211a in the slot 23 depends on specific requirements. If necessary, the first part 211a can be entirely inserted into the slot 23. As the stopper 211 is disposed between the engaging elements 2321a and 2321b and the first and second parts 221a, 221b are fixed, the lead 222 is pressed and fixed by the stopper 211. Along with the engaging elements 2321a, 2321b and the body 221 of the lighting element 22, the lighting element 22 is also strongly fixed to the housing 21.

As described above, the lighting element 22 is mechanically fixed by the engaging elements 2321a, 2321b and the stopper 211, eliminating the need for a gluing or baking process, which eliminates possibility for damage of the lighting element 22 due to a heating process. In addition, as the engaging elements 2321a, 2321b are deformable, the lighting element 22 can be removed from the housing 21 without destroying the housing 21. The connector 2 can be used to receive another lighting element 22, which saves costs for reworking.

While the invention has been described by way of example and in terms of preferred embodiment, it is to be understood that the invention is not limited thereto. To the contrary, it is intended to cover various modifications and similar arrangements as would be apparent to those skilled in the Art. Therefore, the scope of the appended claims should be accorded the broadest interpretation so as to encompass all such modifications and similar arrangements.

What is claimed is:

1. A housing of a connector for receiving at least one lighting element, comprising:
a slot for receiving the lighting element and having a plurality of engaging elements disposed; and
a stopper disposed at an open side of the slot;
wherein the engaging elements contacts the lighting element, and the stopper abuts the lighting element and the engaging elements.

2. The housing as claimed in claim 1, wherein the slot is defined by a bottom and two lateral walls extending from the bottom along a longitudinal direction and the engaging elements are disposed on the lateral walls.

3. The housing as claimed in claim 2, wherein the engaging elements are integrally formed with the lateral walls as a monolithic piece, or attached to the lateral walls by binding, engaging, latching or welding.

4. The housing as claimed in claim 1, wherein the engaging elements are stripe-shaped and made of a material capable of temporally deforming.

5. The housing as claimed in claim 1, wherein the lighting element has at least one lead for being abutted by the stopper.

6. The housing as claimed in claim 1, wherein the stopper has a first part and a second part, and the first part is received in the slot.

7. The housing as claimed in claim 6, further comprising a hole for accommodating the second part.

8. The housing as claimed in claim 6, wherein the first part abuts the engaging element and the lighting element.

9. The housing as claimed in claim 1, wherein the stopper is made of polymer.

10. A connector comprising:
a lighting element; and
a housing comprising:
a slot for receiving the lighting element and having a plurality of engaging elements; and
a stopper disposed at an open side of the slot.

11. The connector as claimed in claim 10, wherein the slot is defined by a bottom and two lateral walls extending from the bottom along a longitudinal direction, and the engaging elements are disposed on the lateral walls.

12. The connector as claimed in claim 11, wherein the engaging elements are integrally formed with the lateral walls as a monolithic piece, or attached to the lateral walls by binding, engaging, latching or welding.

13. The connector as claimed in claim 10, wherein the engaging elements are stripe-shaped and made of a material capable of temporally deforming.

14. The connector as claimed in claim 10, wherein the lighting element has at least one lead for being abutted by the stopper.

15. The connector as claimed in claim 10, wherein the stopper has a first part for receiving the slot and a second part.

16. The connector as claimed in claim 15, wherein the housing further comprises a hole for accommodating the second part.

17. The connector as claimed in claim 15, wherein the stopper partially covers the lighting element, and the first top abuts the engaging element and the lighting element.

18. The connector as claimed in claim 11, wherein the stopper is made of polymer.

19. The connector as claimed in claim 11, further comprising a cover disposed above the housing and reveals the slot.

20. The connector as claimed in claim 11, wherein the lighting element is a light emitting diode, an organic electroluminescent device or a laser diode.

21. The connector as claimed in claim 11, wherein the pins are connected to a specific terminal, and the specific terminal is a RJ-45 connector, a RJ-11 connector or a USB connector.
